(19) United States
(12) Patent Application Publication
(10) Pub. No.: US 2011/0272503 A1
(43) Pub. Date: Nov. 10, 2011

(54) SYSTEMS AND PROCESSES FOR PRODUCING HIGH PURITY TRONA

(75) Inventors: Jan Dean Miller, Salt Lake City, UT (US); Mehmet Sabri Celik, Istanbul (TR); Orhan Ozdemir, Salt Lake City, UT (US); Mustafa Cinar, Kutahya (TR); Vishal Gupta, Salt Lake City, UT (US)

(73) Assignee: UNIVERSITY OF UTAH RESEARCH FOUNDATION, Salt Lake City, UT (US)

(21) Appl. No.: 12/741,946

(22) PCT Filed: Nov. 10, 2008
(86) PCT No.: PCT/US2008/083032

§ 371 Date: Mar. 18, 2011

Related U.S. Application Data
(60) Provisional application No. 60/986,540, filed on Nov. 8, 2007.

(51) Int. Cl. B02C 23/10

(52) U.S. Cl. 241/24.1; 241/79

(57) ABSTRACT

A process of producing high purity trona concentrate includes crushing a mined raw trona (14) to form a crushed raw trona, and separating the crushed raw trona into at least two size fractions (16), wherein a first size fraction is larger than a second size fraction. At least two magnetic separators can be selectively independently adjusted (18,20) to optimize magnetic separation of magnetic impurities from the size fractions. Each of the magnetic separators corresponds to one of the size fractions, which can be separately introduced into the corresponding magnetic separators (22,24) to undergo magnetic separation (26,28,30), which removes magnetic impurities from the size fractions. A first high purity dry trona and a second high purity dry trona may be recovered from the first and second size fractions, respectively. Each of the high purity dry tronas may be combined to form a magnetically purified dry trona.

### FIELD OF THE INVENTION

The present invention is related to processing and purification of trona ores. Accordingly, the present invention involves the fields of chemical engineering, process engineering, materials science, and mining.

### BACKGROUND OF THE INVENTION

Soda ash, an essential raw material used in numerous industries, including the glass, chemical, soap and detergents, pulp and paper, and water treatment industries, is traditionally produced by chemical and thermal treatment of trona ore. Conventional production of soda ash from trona typically involves complex processes which employ many steps to eliminate insoluble components and other impurities of trona ore. Not only are these conventional treatment processes for trona ore complex, but they also require a substantial amount of energy, resulting in high production costs. Accordingly, the production of high purity trona concentrate at lower energy and overall production cost is of considerable interest to the trona industry.

### SUMMARY OF THE INVENTION

The present invention provides a process of producing high purity trona concentrate. The process includes crushing a mined raw trona to form a crushed raw trona. The crushed raw trona can be separated into at least two size fractions, one of which is larger than the other.

One of at least two magnetic separators can be selectively independently adjusted to optimize magnetic separation of magnetic impurities from the respective size fractions of the at least two size fractions. Preferably, each of the at least two magnetic separators corresponds to one of the at least two size fractions. Each of the at least two size fractions may be separately introduced into the corresponding magnetic separators of the at least two magnetic separators. Each of the size fractions can undergo at least a single stage of magnetic separation to remove magnetic impurities from the respective size fractions of the crushed raw trona, which leaves at least two high purity dry tronas. At least a first high purity dry trona and a second high purity dry trona can be recovered from the first and second size fractions, respectively. Each of the at least two high purity dry tronas may be combined to form a magnetically purified dry trona.

The present invention further provides a system to produce high purity trona concentrate. The system can include a crusher having a raw trona ore therein. The crusher can be configured to form a crushed raw trona, having non-uniform sized particles, from the raw trona ore. A mechanical sizer can be oriented downstream of the crusher to divide the non-uniform sized particles into at least two size fractions, one of which is larger than the other.

The present system can also include plurality of magnetic separators. Each magnetic separator can include at least a single phase of magnetic separation, and each magnetic separator can be oriented to independently receive one of the at least two size fractions. A vessel can be operatively associated with each of the plurality of magnetic separators, and further may be configured to hold a magnetically purified dry trona, which comprises a mixture of the at least two size fractions after each has passed through a corresponding magnetic separator.

The present invention can optionally further include separating gangue materials from the magnetically purified dry trona by flotation. The flotation can be accomplished by emulsifying an oil in an aqueous solution to form an oil-in-water emulsion and forming a saturated trona brine. The magnetically purified dry trona can be added to the saturated brine to form a saturated trona suspension where the magnetically purified dry trona includes trona and gangue material having a high percent solids. The trona can be further conditioned by mixing the saturated trona suspension and the oil-in-water emulsion to form a conditioning solid suspension of the trona and the gangue material. Subsequently, the gangue material can be effectively separated from the trona to form a ultra high purity trona concentrate.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flow diagram of a magnetic separation process of producing high purity trona concentrate in accordance with one embodiment of the present invention;

FIG. 2A is a simplified view of a single stage of magnetic separation in accordance with one embodiment of the present invention;

FIG. 2B is a roller and splitter arrangement in accordance with one embodiment of the present invention;

FIG. 3 illustrates the forces applied to a trona particle on a magnetic roller in accordance with various embodiments of the present invention;

FIG. 4 is a flow diagram of a flotation process for separating gangue materials from the magnetically purified dry trona in accordance with another embodiment of the present invention; and

FIGS. 5A and 5B are XRD results for magnetic and non-magnetic products prepared in accordance with an embodiment of the present invention.

FIGS. 6 and 7 are bar charts illustrating the distribution of insoluble content of a raw trona ore with respect to particle size for two different samples.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a particle” includes one or more of such particles, reference to “a separator” includes reference to one or more of such separators, and reference to “adjusting” includes one or more of such steps.

### DEFINITIONS

In describing and claiming the present invention, the following terminology will be used in accordance with the definitions set forth below.

As used herein, “size fraction” refers to a group or assembly of particles, e.g., trona particles, wherein substantially each particle (e.g. greater than about 97%) has a size that falls within a pre-defined size range. Each particle in a size fraction may or may not be the same size as any other particle(s) in the size fraction; however, substantially all the particles in a specific size fraction will have a size falling within the pre-defined size range. For example, a size fraction of particles ranging from about 1.0 mm to about 0.6 mm can comprise single particles, each of which measures about 1.0 mm or about 0.6 mm or any size in between, such as 0.8 mm, 0.9 mm, 0.75 mm, etc.

The term “saturated trona brine” refers to aqueous compositions that include dissolved trona substantially at or above saturation. Although a saturated trona brine can include some suspended solids, the brine is typically less than about 5 wt % solids, and preferably less than about 2 wt % solids. As trona is soluble, in order to condition and suspend a target trona, the brine is saturated with trona to prevent further dissolving of the target trona that is to be separated from the gangue material. Thus, trona ore can be added to the saturated trona brine to form a saturated trona suspension having a high solids content. The saturated trona suspension therefore has a trona ore concentration which exceeds the solubility of the trona ore in the liquid. Typically, the liquid is water; however, this is not required as other polar liquids or additives can also be used. Further, the saturated trona suspension is most often a slurry having a high solids content, e.g., greater than about 60 wt %.

As used herein, “trona ore” refers generally to raw trona as recovered from natural deposits, though more purified trona ore can also be used. Trona ore typically has a majority content of sodium sesquicarbonate (Na₂CO₃.NaHCO₃.2H₂O), with the remainder being undesirable gangue materials such as silica quartz, dolomite, oil shale, and various trace metals. Typically, raw trona ore comprises from about 80 wt % to about 95 wt % sodium sesquicarbonate. Most known trona ore deposits in the United States are found in the Green River basin near Green River, Wyo., U.S.A. Furthermore, “raw trona ore” indicates that the trona ore has not been subjected to calcination processing.

As used herein, “optimize” refers to an ability to maximize or increase the effectiveness of a process, procedure or application. Optimize also refers to the ability to further achieve a desired result.

As used herein, “substantial” when used in reference to a quantity or amount of a material, or a specific characteristic thereof, refers to an amount that is sufficient to provide an effect that the material or characteristic was intended to provide. Therefore, “substantially free” when used in reference to a quantity or amount of a material, or a specific characteristic thereof, refers to the absence of the material or characteristic, or to the presence of the material or characteristic in an amount that is insufficient to impart a measurable effect, normally imparted by such material or characteristic.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.6 mm to about 0.3 mm” should be interpreted to include not only the explicitly recited values of about 0.6 mm and about 0.3 mm, but also include individual values and sub-ranges within the indicated range. Thus, included in this numerical range are individual values such as 0.4 mm and 0.5, and sub-ranges such as from 0.5-0.4 mm, from 0.4-0.35, etc. This same principle applies to ranges reciting only one numerical value. Furthermore, such an interpretation should apply regardless of the breadth of the range or the characteristics being described.

### Embodiments of the Invention

The present invention teaches both systems and associated processes of producing high purity trona concentrate. In its natural form, raw trona contains pure trona as well as magnetic and non-magnetic impurities. For example, raw trona may comprise 80 percent trona and 20 percent impurities, although potentially any ratio of trona to impurities may exist in raw trona. Some of the minerals considered to be impurities commonly found in trona include, shortite, dolomitic shale, quartz, illite, calcite, and feldspars. Some of these minerals have a higher magnetic susceptibility than trona, such as dolomitic shale and illite. As a result, in accordance with the present invention, these minerals can be successfully separated from the raw trona through a magnetic separation process. Other non-magnetic impurities such as shortite, quartz, calcite and feldspar can be difficult to separate from the trona by a magnetic separation process; however, these types of non-magnetic impurities may be separated from trona through other suitable processes such as, but not limited to, conventional flotation process or the unique flotation process described briefly herein.

Accordingly, the process of the present invention may involve both magnetic separation and/or flotation to separate impurities from the trona ore. In some aspects, either magnetic separation or flotation alone may be sufficient to purify the trona for the desired application. As such, in one aspect, the process can be substantially free of any calcining steps or treatments. Other applications, however, may require the trona to undergo magnetic separation followed by a suitable purification step, e.g. conditioning, flotation, etc.

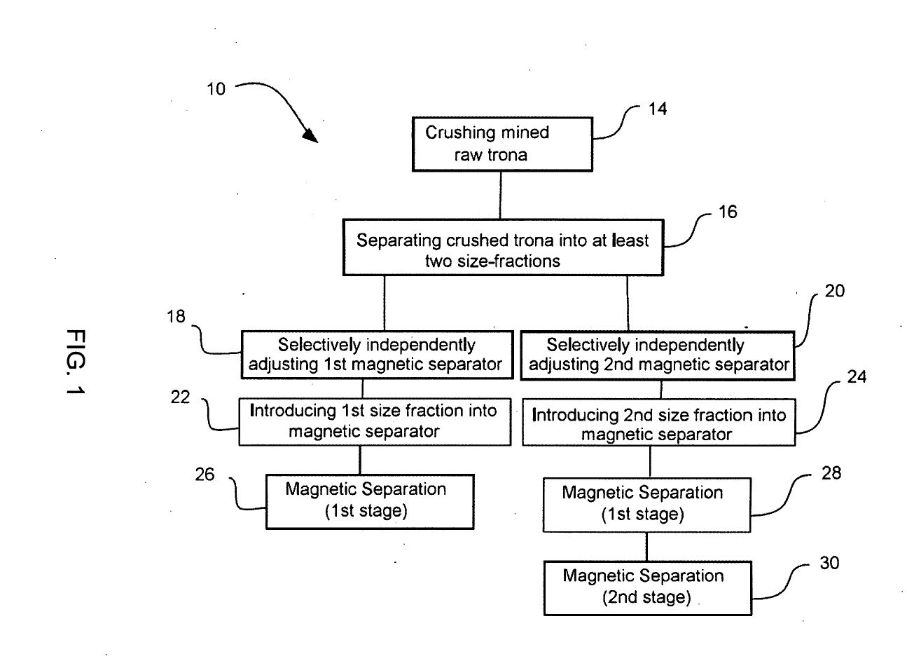

As shown in FIG. 1, the process 10 of producing high purity trona can be initiated by crushing a mined raw trona 14 or previously processed trona ore to form a crushed raw trona. The raw trona may be placed in a crusher configured to crush the raw trona into non-uniform sized particles. According to one aspect, most or substantially all of the non-uniform sized particles can have a size ranging from about 1.0 mm to about 0.15 mm. Typically, the trona content, e.g., percentage of trona relative to impurities, remains constant regardless of the particle size. Accordingly, assuming a raw trona comprises substantially 80 percent trona and 20 percent impurities, each particle of the crushed raw trona likewise can contain substantially 80 percent trona and 20 percent impurities, whether the particle is 1.0 mm, 0.15 mm or any other particle size (although some minor variations in composition tend to occur among fines, e.g. less than about 200 mesh).

According to a preferred aspect, the process 10 of the present invention may further include separating 16 the crushed raw trona into at least two size fractions; although in some aspects, the crushed raw trona can be separated into three or more size fractions. In one aspect of the present invention, the crushed raw trona can be separated into two to six size fractions, and in another embodiment from two to four size fractions. As such, a first size fraction can be larger in size than a second size fraction, the second size fraction can be larger than a third size fraction, and so forth. Each size fraction represents a distinct size range different from the others and chosen based on the particular feed and operating conditions. For example, the first size fraction may comprise particles having a size ranging from about 1.0 mm to about 0.6 mm, the second size fraction may comprise particles having a size ranging from about 0.6 mm to about 0.3 mm, and the third size fraction can comprise particles having a size ranging from about 0.3 mm to about 0.15 mm. Since the first size fraction is typically the largest of the size fractions, it may also be referred to as having coarse particles. Likewise, the second and third size fractions are typically smaller than the first size fraction, and thus may be referred to as having intermediate and fine particles, respectively.

Separating the crushed raw trona into at least two size fractions can be accomplished through the use of a mechanical sizer. According to one aspect, the mechanical sizer can be oriented downstream of the crusher to divide the non-uniform sized particles. Any suitable mechanical sizer can be used which generally have the ability to segregate particles, e.g., non-uniform sized trona particles, according to size. By way of example and not by way of limitation, applicable mechanical sizers can comprise screens and/or sieve shakers.

Once separated into multiple size fractions, one or more size fractions can be further treated and purified by subjection to magnetic separations using suitable magnetic separators. The magnetic separators can be oriented to independently receive one of the at least two size fractions. In one aspect, each magnetic separator can be selectively independently adjusted 18 and 20 to optimize magnetic separation of magnetic impurities from the respective size fractions. This adjustment can include, but is not limited to adjustment of at least one of magnetic roller speed, size fraction feed rate, separation baffle angle, and magnetic roller type. Each variable can be adjusted to optimize separation efficiencies. For example, the separation baffle can be angled and oriented so as to direct a primarily non-magnetic particulate product away from magnetic product which is retained on the belt longer. Further, excessive roller speed can result in premature loss of magnetic particles from the belt. Feed rates can also affect separation efficiency, e.g. excessive particles may prevent magnetic particles from being retained by the magnetic rollers.

As noted, the size fraction feed rate can also be adjusted and optimized for each separation step. Feed rate can vary the separation efficiency substantially. Rare earth magnetic separators, in particular, are sensitive to feed rate. For the rare earth magnetic separator Eriez earth magnet, for example, the separation recovery is greatly reduced at feed rates of greater than about 5 tons per hour (tph). A useful initial feed rate setting is about 0.5 to about 3 tph, and more specifically about 1 tph. Typically, a belt on a rare earth magnetic separator can be about 15 cm wide, although any belt width could be used, such as, for example, belt widths of about 2.5 cm to about 150 cm. Based on the 15 cm belt width, the feed rate can range, for example, from about 3.3 tph/m (for feed rate of about 0.5 tph) to about 33.3 tph/m (for a feed rate of about 5 tph). A feed rate of about 1 tph likewise is equal to a feed rate unit scale of about 6.7 tph/m. Generally, roll width of the rare earth magnetic separator varies from about 2.5 cm to about 150 cm. The belts and rolls of the magnetic separator can be in any configuration that allows for the desired separation, including multiple belts associated with a single roll, and/or multiple rolls aligned along a single common axis.

Particle size of the fraction being separated can affect the capacity and the optimum separation feed rate for the separator. For example, smaller particle sizes of less than about 2 mm, relates to an upper limit of feed rate about 6 tph/m. For larger particles, the feed rate can be higher, for example, 15 tph/m or even 33.3 tph/m, and still maintain effective separation. When optimizing the feed rate, generally the feed rate is incrementally increased and the efficiency is determined. After exceeding a certain feed rate, the separation efficiency decreases, which indicates moving away from optimum conditions. It should be noted, also, that optimum feed rate depends on rotor speed, and any alteration to the rotor speed of the rare earth magnetic separator, or any other magnetic separator, might require re-optimization or likewise adjustment of processing conditions.

Generally, each of the at least two magnetic separators corresponds to one of the at least two size fractions. Thus, by way of example, a first size fraction can be separately introduced into and correspond to a first magnetic separator, a second size fraction can be separately introduced into and correspond to a second magnetic separator, and so forth. Preferably, each of the magnetic separators has at least a single stage and thus, upon introduction into the corresponding magnetic separators, each of the at least two size fractions may undergo at least a single stage of magnetic separation. In some aspects, however, each of the at least two size fractions may undergo two or more stages of magnetic separation to remove magnetic impurities from the trona.

As mentioned previously, particular size fractions can undergo at least a single stage of magnetic separation to remove magnetic impurities from the respective size fractions by introducing each fraction into a corresponding magnetic separator 22 and 24. In some cases, one or more of the size fractions can undergo more than a single stage of magnetic separation, as shown on the right column of FIG. 1, wherein there are two stages of magnetic separation 28 and 30. The number of stages of magnetic separation in which a size fraction undergoes may depend on a number of factors. The factors include, but are not limited to the intended application of the purified trona, the amount of magnetic impurities contained in the raw trona, the type of impurities contained in the raw trona, and the average size of the particles in the size fraction being magnetically separated. Although a single stage is often sufficient for most crushed trona feed, up to three stages may be useful. More than three stages could be useful, although costs may outweigh the relatively smaller incremental increases in separation efficiencies offered by such additional stages.

Magnetic separation may be achieved by introducing the crushed raw trona into a magnetic separator. In one aspect, at least two magnetic separators may be used. Numerous types of magnetic separators may be used to practice the present invention. In one aspect, the separation is conducted using a roll-type rare-earth permanent, belt-type magnetic separator commercially available from Eriez Magnetic Ltd. In these types of devices a belt is driven about two rollers, at least one of which includes a permanent magnet. Magnetic particles are retained on the belt when in proximity to the magnetic roller. Magnetic particles travel around the roller and are retained while non-magnetic particles fall from the belt. As the belt continues to travel, the magnetic particles fall away as proximity to the magnetic roller decreases. In this manner, each of the non-magnetic and magnetic particles can be separately collected. In one aspect, a plurality of magnetic separators may be used sequentially, each having at least a single stage for performing magnetic separation. According to some aspects, one or more of the magnetic separators can have multiple stages so that the size fraction being purified can undergo two or more stages of magnetic separation in a single separator. In such cases, the processing parameters for the particular magnetic separation step can be independently optimized to produce the greatest separation efficiency. Such parameters may be the same, similar to, or different from the previous and/or subsequent magnetic separation step(s).

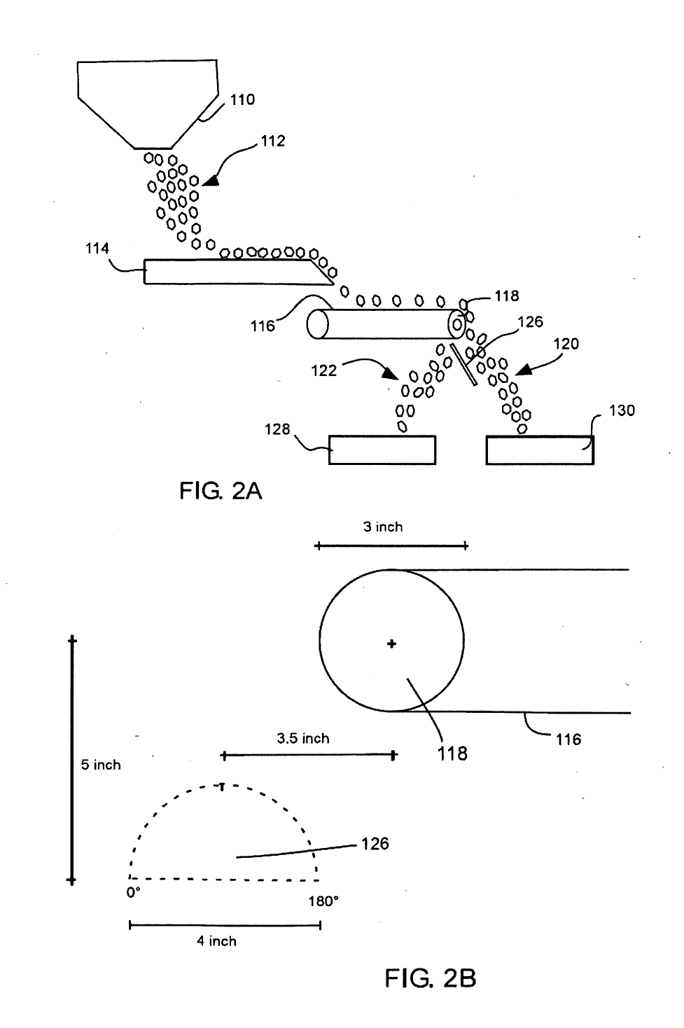

A single stage of magnetic separation can include multiple steps or processes. Likewise, a magnetic separator can include numerous components, many of which are used for performing different steps in the magnetic separation process. In one aspect, as illustrated in FIG. 2A, the magnetic separation process comprises feeding a stream of crushed trona particles into a hopper 110. The hopper can receive, temporarily hold, and discharge the particles 112. The trona particles can be separated into their respective size fractions prior to being fed into the hopper. In this way, the stream of particles fed into the hopper would comprise only one of the at least two size fractions, e.g., the first size fraction. In another aspect, the hopper may receive crushed raw trona having non-separated, non-uniform sized particles. In this aspect, the hopper can have a corresponding mechanical sizer (not shown) that will sort the crushed particles into their respective size fractions so as to discharge the crushed particles according to their size. Thus, by way of example, the hopper may discharge a first size fraction onto a first conveyor belt, and discharge a second size fraction onto a second conveyor belt. Alternatively, the hopper can discharge a first size fraction onto a conveyor belt for immediate continuation of the magnetic separation process and temporarily hold a second size fraction for a separate magnetic separation process distinct from that of the first size fraction.

One of the at least two size fractions of raw crushed trona particles 112 may be discharged or unloaded from the hopper 110 onto a vibratory feeder 114, which can be oriented above a conveyor belt 116. The vibratory feeder can be configured to discharge and distribute the particles over the conveyor belt. The particles can be distributed uniformly across the width of the conveyor belt. Particles distributed on the belt can preferably be distributed in a monolayer via vibration, adjustment of feed rates, etc. in order to improve retention of magnetic particles, although this is not necessarily required.

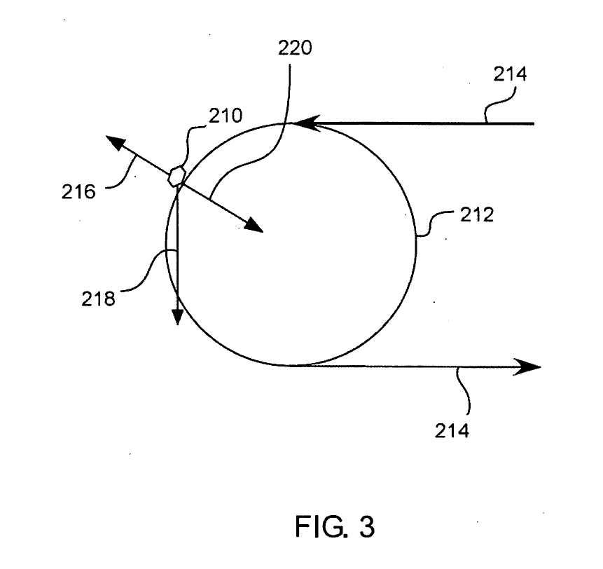

The conveyor belt 116 can transfer the particles 112 to or pass the particles over a magnetic roller 118 associated with the conveyor belt. The magnetic roller can be configured to release substantially non-magnetic particles 120 and to retain substantially magnetic particles 122 and at least a portion of the magnetic impurities. In one aspect and as depicted in FIG. 3, the magnetic roller 212 is configured to apply multiple forces to particles 210 thereon to achieve magnetic separation. The arrows referenced as 214 shown the rotational direction of the magnetic roller. A magnetic force 220, centrifugal force 216, and gravitational force 218 are all acting on the trona particles to facilitate separation of the substantially magnetic particles and substantially non-magnetic particles. Each of these forces can be adjusted by varying the variables identified previously, e.g. magnetic roller speed, size fraction feed rate, separation baffle angle, and magnetic roller type, in order to optimize separation efficiency.

In one aspect, the primary force of separation is the magnetic force 220. In a typical magnetic roller, the magnetic field of the separator can be about 21,000 Gauss on the surface of the roll. In another aspect, the magnetic field of the separator can be less than about 20,000 Gauss on the surface of the roll. As a result, a magnetic roller of the present invention may be used for feed size from 0.075 mm to 13.0 mm, although efficiencies can vary depending on the magnetic susceptibility of the impurities.

As a particle approaches the magnetic roller, it enters into a magnetic field associated with the roller, and based on the following possibilities, magnetic separation can take place. The particle can be released from the roller when the sum of gravitational force and magnetic force is less than centrifugal force. This is the case for diamagnetic material of low magnetic susceptibility. On the other hand, when the sum of magnetic force and gravitational force is greater than the centrifugal force the particle will remain in contact with the roller and will be released upon leaving the magnetic field. This is the case for paramagnetic material of high magnetic susceptibility.

The efficiency of magnetic separation can also depend on the size of the particle. The gravitational forces and magnetic force become dominant for particles having a size of about 0.3 mm or larger. As a result, paramagnetic and locked diamagnetic particles report to magnetic products. Alternatively, the gravitational force becomes small for particles having a size less than about 0.3 mm and the centrifugal force dominates the magnetic force. As a result, the magnetic particles may report to non-magnetic products. Generally, the separation efficiency of magnetic separation decreases with a decrease in particle size.

Referring again to FIG. 2A, a splitter 126 can be oriented spaced from and near the magnetic roller 118 sufficient to segregate the non-magnetic particles 120 from magnetic particles 122. Depending on the position and angle of the splitter, which can be each adjusted, separation of magnetic and non-magnetic or diamagnetic material takes place. Separation efficiency can be affected significantly by changing the angle of the splitter. Furthermore, separation efficiency can be affected significantly by optimizing other processing parameters in addition to modifying the angle of the splitter. In a preferred aspect, the splitter can be a moveable separation baffle oriented to direct non-magnetic particles 120 separately away from magnetic particles 122. Although optimal parameters can vary depending on the trona feedstock, splitter angles for the second smaller (and optionally third) size fraction can exceed the first (coarser) size fraction. For example, FIG. 2B illustrates a single example of a splitter 126 and roller 118 configuration where the angle is measured from the horizontal with the zero degree splitter position being when the splitter is horizontal and pointing away from the magnetic pulley on the belt (e.g. in this case shown at the 90° position). In this arrangement, the splitter angle associated with the first coarser size fraction can range from about 88-94° and in some cases from 90-92°, while the splitter angle for the second and third size fractions can range from about 94-100°, and in some cases from about 95-98°. However, optimal angles can depend on the distance from the roller, speed of the belt, and specific particle sizes/types being separated.

The present invention is particularly adapted for use with trona ores having magnetic, e.g. paramagnetic or ferromagnetic, components therein. Magnetic impurities having a positive, non-zero magnetic susceptibility can be readily separated. Non-limiting examples of such magnetic impurities include dolomitic shale, illite, chalcopyrite, pyrite, hematite, magnetite, and iron.

Preferably, the resultant product produced from the magnetic separation is at least two high purity dry tronas (not shown in FIG. 2), including at least a first high purity dry trona and a second high purity dry trona recovered from the first and second size fractions, respectively. The substantially non-magnetic, high purity trona 120 can be collected in a first receiving member 130. The substantially magnetic particles 122 and magnetic impurities can be removed from the magnetic roller 118 and collected in a second receiving member 128. Preferably, each of the receiving members can be oriented to conveniently collect the respective particles. These receiving members can be any suitable container or member, depending on the designed process. For example, the receiving members can be bins, hoppers, funnels, vessels (for subsequent processing), etc. or even a second or subsequent magnetic separator belt as described previously.

According to one aspect, a single vessel can be operatively associated with each of the plurality of magnetic separators to hold the magnetically purified dry trona. In one aspect, the vessel can be configured to hold a mixture or combination of the purified dry trona from the at least two size fractions. Alternatively, each of the magnetic separators may be operatively associated with separate vessels to avoid combining the at least two size fractions.

Occasionally, the magnetically purified dry trona can be further purified.

In accordance with the present invention, the magnetically purified dry trona can have a purity by weight of about 92% trona, although other purities such as, but not limited to, about 88% to 96% trona can also be achieved, depending on the starting material and specific operating conditions.

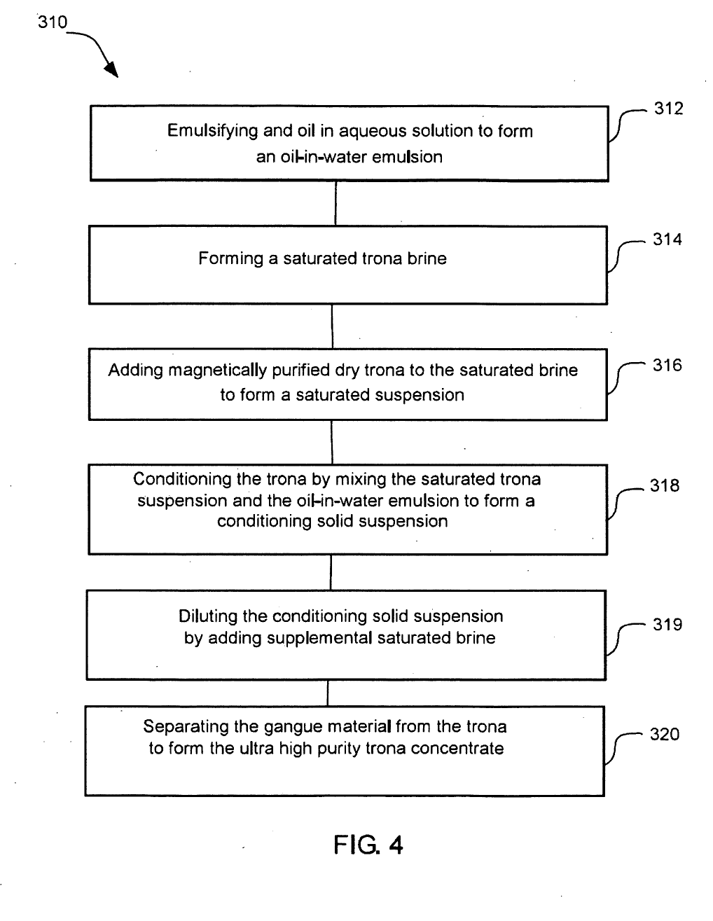

In some instances further purification may be beneficial, or even necessary, to achieve a particular or desired grade of trona, although this is not always required. It should be noted, however, that the primary mode of separation in the process disclosed herein is the magnetic separation. Accordingly, the process of the present invention can include a flotation process 310, as illustrated in FIG. 4, to separate gangue materials from the magnetically purified dry trona to produce an ultra high purity trona concentrate. In one aspect, an oil-in-water emulsion can be very effective for furthering purification. The process can include emulsifying an oil in an aqueous solution to form the oil-in-water emulsion 312. Separately, a sufficient amount of trona or trona ore can be dissolved in an aqueous solution to form a saturated trona brine. Additional trona ore can be optionally added to the saturated trona brine to form a saturated trona suspension having a desired solids content. The undissolved trona in the trona suspension can then be conditioned by mixing the saturated trona suspension and the oil-in-water emulsion to form a conditioning solid suspension of trona and gangue material. Conditioning for a period of time ranging from about 1.5 to 3 minutes is generally sufficient, although longer conditioning times can sometimes be helpful. The gangue material and conditioned solid suspension of trona can then be separated to produce a trona concentrate, e.g. via flotation.

The emulsion can be formed of an oil phase and an aqueous phase as described in more detail herein. For example, the emulsion can include an emulsifier. Such an emulsifier can have the dual purpose of promoting emulsification and promoting attraction between the gangue material and the oil phase of the oil-in-water emulsion. As stated, in one embodiment, oil can be emulsified into an aqueous solution with an emulsifier, such as a surfactant with an amine functionality, to form an oil-in-water (O/W) emulsion. For example, a dodecylamine composition can be used as the emulsifier, e.g., dodecylamine hydrochloride or dodecylamine acetate. Other emulsifiers can include, but are in no way limited to, alkylamine hydrochlorides or acetates such as dodecylamine hydrochloride, dodecylamine acetate, hexadecylamine hydrochloride, hexadecylamine acetate, fatty amines such as stearic amine and cetyl amine, triethanolamine lauryl sulfate, amine oxide surfactants such as C₁₀-C₁₈ alkyl dimethyl amine oxides, C₈-C₁₂ alkoxy ethyl dihydroxyethyl amine oxides, alkyl amido propyl amine oxide, dimethyloctyl amine oxide, diethyldecyl amine oxide, bis-(2-hydroxyethyl) dodecyl amine oxide, dimethyldodecyl amine oxide, dodecylamidopropyl dimethyl amine oxide and dimethyl-2-hydroxyoctadecyl amine oxide, and derivatives or mixtures of the above emulsifiers. Other suitable emulsifiers can include non-amine surfactants such as, but not limited to, hexadecyltrimethyl ammonium bromide, cetyltrimethyl ammonium bromide, cetylpyridinium bromide, dodecyl benzene sulfonates, polypropylene benzene sulfonates having 10 to 18 alkyl carbons, dibutyl naphthalene sulfonates, diisopropyl naphthalene sulfonates, alkyl compounds such as octyl sulfates, nonyl sulfates, decyl sulfonates, lauryl sulfates, coconut alcohol sulfates, tridecyl alcohol sulfates, tallow alcohol sulfates, cetyl sulfates, oleyl sulfates, N-alkyl taurates, polyoxyethylene nonylphenyl ether, magnesium laurate, zinc caprate, zinc myristate, sodium phenylstearate, aluminum dicaprylate, tetraisoamyl ammonium thiocyanate, tri-n-butyl-n-octadecylammonium formate, n-amyl tri-n-butylammonium iodide, sodium bis(2-ethylhexyl) succinate, sodium dinonylnaphthalene sulfonate, calcium cetylsulfate, dodecylamine oleate, dodecylamine propionate, cetyltrimethyl ammonium halide, stearyltrimethyl ammonium halide, dodecyltrimethyl ammonium halide, octadecyltrimethyl ammonium halide, didodecyldimethyl ammonium bromide, ditetradecyldimethyl ammonium bromide, ditetradecyldimethyl ammonium chloride, (2-octyloxy-1-octyl oxymethyl) polyoxyethylene ethyl ether, and mixtures thereof. The remainder of the aqueous phase can be water and/or other polar solvents, and any other optional additives known in the art. Although other compositions can be used, the emulsifier can generally comprise from about 0.1 wt % to about 10 wt % of the aqueous phase in the emulsion.

Typically, the oil phase can comprise a water insoluble non-polar compound. Though any functional oil can be used, typical oils for use can include kerosene, fuel oil, mineral oil, gasoline, diesel oil, and mixtures of these oils. Fuel oil is readily available and can be an effective oil for use in the present invention. In one aspect, the oil in the emulsion can be any liquid hydrocarbon oil, such as C₆ to C₂₄ aliphatic hydrocarbons, mineral oils, natural oils, or the like. The oil-in-water emulsion can be added as a collector composition to the solid suspension or the saturated trona brine to aid in conditioning the high solids content of the gangue material, thereby preparing the gangue material for subsequent flotation separation.

In an exemplary embodiment, the weight ratio of emulsifier, such as an amine-containing surfactant, to oil can be from about 1:4 to about 1:14 by weight, and preferably from about 1:8 to about 1:12. The amount of emulsion required to achieve acceptable conditioning of the trona is extremely low in comparison to the volume of saturated brine to be conditioned. As a general rule, the emulsion composition can be added to provide from about 0.5 to about 1.5 kilograms emulsifier per ton of suspended solids, and about 1 to about 10 kilograms oil per ton suspended undissolved solids.

In accordance with an embodiment of the present invention, a raw trona ore can be mixed with a liquid such as water. Referring again to FIG. 3, a sufficient amount of raw trona ore can be added to form a saturated brine of the trona ore 314. The saturated trona brine can then be mixed with additional trona ore to produce a saturated trona suspension 316, where the trona ore is present in an amount which exceeds the trona solubility in the aqueous phase. Most preferably, the saturated brine has a high solids content. Thus, in accordance with one embodiment of the present invention, the trona ore can be present in a sufficiently high amount that the solids content of the saturated trona suspension and the conditioning solids suspension is from about 50 wt % to about 85 wt % solids, and in one embodiment, from about 60 wt % to about 75 wt % solids. The trona ore can be provided at any size which is sufficient to allow conditioning 318 and separation 320 in accordance with the present invention. Although other size ranges can be functional, trona particle sizes in the suspension can range from about 0.05 mm to about 3 mm, and are typically from about 0.1 mm to about 1.5 mm, e.g., particles of about 0.1 mm by about 1 mm. A small particle size will tend to provide increased surface area for separations, as well as allow the particles to stay in suspension for a time sufficient for conditioning.

As a general guideline in forming a saturated trona brine, the solubility of pure trona in water can range from about 10 wt % to about 30 wt %, depending on the temperature. At room temperature, the solubility of trona in water is about 20 wt %. In addition, it should be noted that merely dissolving trona in solution can liberate heat through an exothermic process. Trona typically has a positive heat of solution from about 30 BTU/lb trona to about 50 BTU/lb trona, e.g., about 49.5 BTU/lb at 25° C. in water to give a 0.3% solution and about 32 BTU/lb in a nearly saturated mother liquor. This is a similar property found in sodium carbonate systems. Typically, the solubility of sodium carbonate reaches a maximum of about 33.2 wt % in water at about 35.4° C. The solubility of sodium carbonate does not generally increase with increased temperatures above 35.4° C. On the contrary, solubility decreases at higher temperatures. In addition, dissolving trona ore in water is most often a relatively highly exothermic process. For example, anhydrous sodium carbonate and sodium carbonate monohydrate have positive heats of solution. In contrast, sodium carbonate heptahydrate and sodium carbonate decahydrate each have negative heats of solution.

As another guideline in performing the process of the present invention, the trona ore can be conditioned 318 with the emulsion at 70 wt % to 75 wt % solids in the saturated trona suspension at ambient temperature. However, a solids content from about 50 wt % to about 85 wt % can be functional.

An alternative step of diluting the conditioning solid suspension 319 can be carried out by adding supplemental saturated brine as an intermediate step between conditioning 318 and separating the gangue material 320. The supplemental saturated brine can be provided from a mother liquor or other feed from an associated sodium bicarbonate process. Alternatively, the supplemental saturated brine can be formed by adding raw trona ore in an amount such that the solids content is very low, e.g., less than about 10 wt % and preferably less than about 5 wt %, and most preferably less than about 1 wt %. The slurry suspension can then be diluted to about 10 wt % to about 20 wt % solids for separation of the gangue minerals (e.g. by flotation) from trona 320. Though these details are provided, the invention is not limited to these ranges, reagents, or conditions. For example, the solids content prior to dilution can be from about 60 wt % to about 80 wt %, and after dilution, from about 5 wt % to about 30 wt %.

Emulsification processes can affect the amount of emulsion reagent required to provide acceptable results in accordance with embodiments of the present invention. When an oil-in-water emulsion is prepared with a high speed mechanical emulsifier, the dosage can be reduced. For example, in one embodiment, with lower intensity mixing, the emulsion reagent dosage required might be about 0.94 kg dodecylamine per ton undissolved solids and 7.5 kg kerosene per ton undissolved solids. On the other hand, only 0.94 kg dodecylamine per ton and 2.8 kg kerosene per ton are needed when the emulsion is prepared using high speed mechanical emulsification. Without being bound by any particular theory, when using higher speed emulsification, such as by the use of a high speed or high shear mixer, a greater surface area of the discontinuous oil phase of the emulsion can be realized, which can reduce the required dosage.

The step of conditioning 318 can be accomplished by simply mixing the saturated brine and the emulsion together. Although the optimal time and mixing conditions are best determined by standard practice of the present invention, typical conditioning times can range from about 1 minute to about 5 minutes at temperatures within about 40° C. of ambient. Of course, conditioning times can be adjusted by varying the mixing intensity and/or emulsion content of the suspension.

As mentioned previously, the process of the present invention can be beneficial in significantly reducing the need for additional costly heat to remove unwanted gangue material. Thus, in some embodiments, the formation of a trona concentrate can be accomplished without the addition of heat, e.g., carried out at substantially ambient conditions. In one detailed aspect, at least the step of conditioning 318 can occur at a temperature from about 2° C. to about 60° C. Most often, the temperatures of each step can occur at a temperature from about 10° C. to about 50° C. However, it should be kept in mind that temperatures outside even the broader range can be useful, depending on available materials and their corresponding heat values.

Separation of the conditioned trona from the gangue material 320 can be accomplished using any number of methods. Non-limiting examples of suitable processes can include flotation, settling, skimming, clarifying, centrifuging, decanting, combinations thereof, or the like. In one specific embodiment, a gas can be injected through the conditioned solid suspension of trona and gangue material in order to float the gangue material. Typically air is used as the flotation gas; however, other gases can also be used, e.g. nitrogen or the like.

Optionally, an additional flotation reagent can be added to enhance recovery of the gangue materials from the conditioned solid suspension. Additionally, many flotation processes can be used in connection with the present invention to separate gangue material from trona material. For example, a flocculating agent can be added to the suspension in order to accelerate and improve the recovery of gangue material from the suspension to leave the purified trona concentrate.

Once the gangue material has been removed, the material that substantially remains is the purified trona and residual emulsion components. The liquid residual components and/or water can be removed by conventional processes and the remaining trona concentrate can then be used as desired. The removed liquid can optionally be recycled for use as either supplemental saturated brine or as make-up feed for any associated sodium bicarbonate production process, for example. Alternatively, the liquid residual components can be left in the purified trona concentrate so that the composition is in the form of a slurry which can be fed directly to an associated production process. Thus, the product of the present invention can be utilized as a feed stock which can be completely dissolved and then clarified and crystallized using known techniques. In yet another embodiment, the liquid or dry trona concentrate can be provided as a commercial product for use at a separate site.

Purified trona concentrate can be used directly such as glass production, pH control or for a wide variety of purposes such as, but not limited to, formation of sodium carbonate (soda ash), sodium bicarbonate (baking soda), sodium hydroxide, sodium sesquicarbonate feed, sodium phosphate, or the like. These products have a wide range of applications ranging from food products and medicines to glass production, paper production, detergents, chemical synthesis, and many other applications.

Regardless, the processes of the present invention can yield a trona concentrate comprising up to and greater than 98 wt % or even 99 wt % Na₂CO₃.NaHCO₃.2H₂O. In one embodiment, the concentrates can include less than 2 wt % gangue materials, or even less than 1 wt % gangue materials.

When mined, trona ore is a dry material that is present with other dry gangue components that are undesirable. Without being bound to any particular theory, the conditioning step 318 can provide a means of suspending and wetting the trona in a solution, without dissolving the trona. In other words, as trona is soluble in water, a saturated solution is used to prevent solubilization of the target trona to be separated from the gangue material. Introduction of the emulsion into the saturated brine and into contact with the trona and gangue material provides a precursor composition wherein the gangue material is susceptible to flotation. Thus, upon introduction of gas or air into the composition, air bubbles attach to the hydrophobic gangue particles, thereby causing separation by flotation of the hydrophobic gangue particles. As the gangue material is primarily silica quartz, dolomite, and oil shale, the emulsion, which can include an amine functionality via the emulsifier, is attracted to the gangue material. Thus, when the air becomes attracted to the oil, the gangue material can be floated with the rising air bubbles. The amount of air injected into the suspension is readily ascertainable by one skilled in the art after considering the present disclosure.

In one aspect of the present invention, the process steps in accordance with embodiments of the present invention can be integrated into known sodium carbonate production processes. For example, the method of the present invention can be incorporated into an existing sesquicarbonate process. However, it will be understood that any known process for use or collection of trona materials can be used in connection the present invention, e.g., monohydrate process, sesquicarbonate process, or variations thereof. In one aspect, a modified sesquicarbonate process raw trona ore is initially treated by a crushing and screening step to effect a size reduction, followed by magnetic separations as described previously to obtain a magnetically purified dry trona. A flotation step can be practiced according to embodiments of the present invention between the crushing, screening and magnetic separation steps and a standard dissolution step. Gangue and other undesirable materials can be separated and removed as a waste. In a currently practiced process of the prior art, material from the crushing and screening can often go through a typical flotation step and then directly to dissolution.

By performing the flotation step in connection with the magnetic separations in accordance with the principles of the present invention, the above-discussed efficiencies can be realized. For example, heating can be significantly reduced or eliminated and increased purity of the trona obtained. In this way, the slurry product of conditioned trona can be introduced into the dissolution step, followed by the standard, and known, steps of clarification, thickening, carbon treatment, filtration, crystallization, centrifugation, calcinations, cooling/drying, and collection/packaging of soda ash product, if desired. Makeup water can be provided as needed throughout the process, e.g., in the thickening step, and waste can be removed and treated or disposed of using conventional process, e.g., evaporation ponds, biodegradation, remediation, or the like. These steps are merely exemplary and can be modified or substituted using known processes or processes yet to be developed which are useful in the production of soda ash. In one embodiment, for example, the process can be substantially free of calcinations. In another embodiment, the process can be substantially free of calcinations prior to flotation.

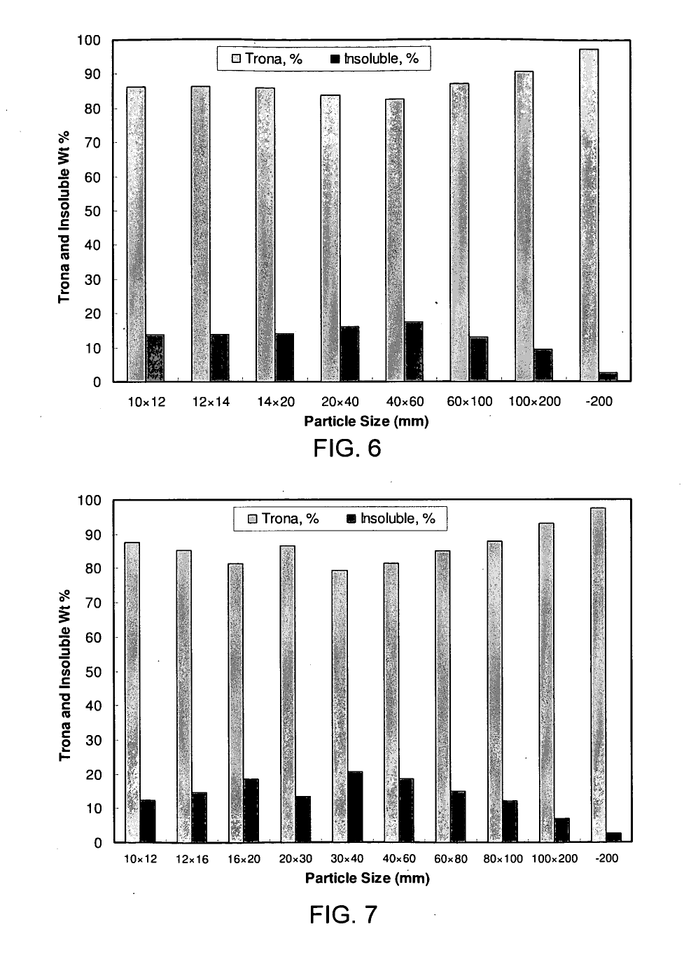

In this manner, rare earth magnetic separators, as utilized according to the presently-disclosed methods, can be very effective in separating high purity trona in a variety of size fractions, including particles of less than about 1 mm. In one embodiment, the narrow size can increase the separation efficiency, as demonstrated by experiments with three different size fractions; 1×0.6, 0.6×0.3, and 0.3×0.150 mm. Although the roll separators could be used to recover the particles up to 13 mm, as known from the literature, the roll separators are very effective in treating fine particles less than 1 mm. These experiments were performed below 1 mm. FIG. 6 and FIG. 7 show the distribution of insoluble content of the trona ore with respect to particle size. These trona ores were obtained from the General Chemical Corp. (Green River, Wyo.) at different times. As seen from the figures, the insoluble content of the trona ore decreases as the particle size decreases, particularly after 600 micron. It is interesting to note that although these two ores were obtained at different times, the trona and insoluble content of the feeds are almost same. As seen from the figures, the minus 200 mesh fraction contains less than 3% insoluble content; hence, this size fraction can be used directly as a trona concentrate. The overall insoluble contents for the samples are about 11.9%, and 11.3% for the feeds, respectively.

A further modification is the production of a new and marketable product, a trona concentrate, by subjecting the material from the flotation step to the steps of filtration, and drying of conditioned trona material from the flotation step. The resulting dried product is collected as a solid trona concentrate in a collection step. Filtration and drying steps can be accomplished using any known methods such as those commonly used in production of soda ash, e.g., settling tanks, sieves, clarifiers, heated drums, etc. Those skilled in the art will readily envision economically appropriate systems for accomplishing these simple steps of filtration and drying. The dried trona concentrate can then be delivered to a customer in bulk and/or packaged for commercial sale.

### EXAMPLES

A natural trona sample was obtained from the Green River Formation in Wyoming. The sample (bulk density, 0.97 g/cm³) was taken from the crushing circuit before calcination. The sample was separated or classified into three different particle size fractions by sieve shaker: 1.0×0.6 mm, 0.60×0.3 mm, and 0.30×0.15 mm. The weight percent of each size fraction screened from the trona feed material is presented in Table 1.

TABLE 1
Particle size distribution and trona content of the sample

| Size | Weight | Insoluble Content | Trona Grade |
|---|---|---|---|
| (mm) | (%) | (%) | (%) |
| 1.0 × 0.60 | 50.3 | 19.9 | 80.0 |
| 0.60 × 0.30 | 29.5 | 20.1 | 79.9 |
| 0.30 × 0.15 | 20.2 | 16.9 | 83.0 |
| Total | 100.0 | 19.4 | 80.6 |

The trona content remained substantially constant at about 80%, and did not change appreciably with decrease in particle size. The overall insoluble impurities in the feed as well as in each size-fraction were nearly the same, about 20%, with a little less at about 17% for the 0.3×0.15 mm size fraction. The magnetic properties of minerals present in trona ore are listed in Table 2.

TABLE 2
Minerals and magnetic properties present in trona ore

| Mineral | Specific Gravity | Magnetic |
|---|---|---|
| Component | (g/cm³) | Susceptibility |
| Trona | 2.14 | Nonmagnetic |
| Shortite | 2.60 | Nonmagnetic |
| Dolomitic Shale | 2.10-2.13 | Paramagnetic |
| Quartz | 2.66 | Nonmagnetic |
| Illite | 2.4-3.0 | Paramagnetic |
| Calcite | 2.71 | Nonmagnetic |
| Feldspars | 2.54-2.72 | Nonmagnetic |

It can be seen that dolomitic shale and illite have a higher magnetic susceptibility than trona and can be separated by magnetic separation. Other non-magnetic impurities such as shortite, quartz, calcite and feldspar in trona ore are more difficult to separate by magnetic separation. Flotation can be useful to remove these non-magnetic impurities.

A roll type rare-earth permanent, belt type, magnetic separator, obtained from Eriez Magnetic Ltd., (model #RE-5-1 Lab, 4 inch roll) was used for the magnetic separation of trona ore. The ore of each size classification was separately fed into a hopper which discharged the feed uniformly on to a vibratory feeder across the width of the belt at a feed rate of roughly 1 ton per hour. The particulate material goes over the magnetic roller and, depending on the splitter position, separation of magnetic and non-magnetic or diamagnetic material takes place. The magnetic separator can be used for feed size from 0.075 to 13 mm. The magnetic field of the separator is 21,000 Gauss on the surface of the rolls. It should be noted that alternatively, another aspect, the magnetic field of the separator can be less than about 20,000 Gauss on the surface of the rolls.

The magnetic separation of the trona ore was conducted for three different size fractions, e.g., 1.0×0.6 mm, 0.6×0.3 mm, and 0.30×0.15 mm. This size fractionation improved the recovery and hindered the formation of aggregates between fine and coarse particles. The magnetic separation was conducted in two stages for each size fraction to improve the recovery and grade with a second stage of magnetic separation.

The feed rate (monolayer of particles on the conveyor belt) was varied from 27 kg/hr to 37 kg/hr with an increase in feed size from 0.30×0.15 mm to 1.0×0.6 mm. The splitter angle with respect to horizontal was determined to be 90-92° for the coarsest size-fraction, and was kept constant at 95-98° for the intermediate and fine size fraction. The magnetic separation process was sensitive to the splitter angle. The maximum roll speed was varied from 30% to 40% of maximum voltage setting with increase in feed size from fine to coarsest size fraction. Results for each of three size fractions are presented in Tables 3, 4 and 5 and discussed thereafter.

TABLE 3
Overall results of magnetic separation of the coarse trona sample
(1.0 × 0.6 mm)

| 1 × 0.6 mm | | |
|---|---|---|
| Feed | Magnetic | Non-Magnetic |

Stage I

| | | | |
|---|---|---|---|
| Weight (%) | 100 | 16.3 | 83.7 |
| Insoluble content (%) | 19.6 | 79.4 | 7.9 |
| Trona Grade (%) | 80.4 | 20.6 | 92.1 |
| Trona Recovery (%) | 100 | 4.2 | 95.8 |

Stage II

| | | | |
|---|---|---|---|
| Weight (%) | 83.7 | 1.6 | 82.1 |
| Insoluble content (%) | 7.9 | 43.1 | 7.2 |
| Trona Grade (%) | 92.1 | 56.9 | 92.8 |
| Trona Recovery (%) | 100 | 1.2 | 98.8 |

Overall

| | | | |
|---|---|---|---|
| Weight (%) | 100 | 17.9 | 82.1 |
| Insoluble content (%) | 19.6 | 76.2 | 7.2 |
| Trona Grade (%) | 80.4 | 23.8 | 92.8 |
| Trona Recovery (%) | 100 | 5.3 | 94.7 |

Operating parameters: Feed rate = 27-37 kg/hr, Splitter angle = 90-92° (coarsest size-fraction) and 95-98° (intermediate and fine size-fraction), and Roll speed = 30-40% of maximum voltage setting

TABLE 4
Overall results of magnetic separation of the
intermediate trona sample (0.60 × 0.30 mm)

| 0.6 × 0.3 mm | | |
|---|---|---|
| Feed | Magnetic | Non-Magnetic |

Stage I

| | | | |
|---|---|---|---|
| Weight (%) | 100 | 15.5 | 84.5 |
| Insoluble content (%) | 19.9 | 74.5 | 9.9 |
| Trona Grade (%) | 80.1 | 25.5 | 90.1 |
| Trona Recovery (%) | 100 | 4.9 | 95.1 |

Stage II

| | | | |
|---|---|---|---|
| Weight (%) | 84.5 | 2.4 | 82.1 |
| Insoluble content (%) | 9.9 | 45.7 | 8.9 |
| Trona Grade (%) | 90.1 | 54.3 | 91.1 |
| Trona Recovery (%) | 100 | 1.7 | 98.3 |

Overall

| | | | |
|---|---|---|---|
| Weight (%) | 100 | 17.9 | 82.2 |
| Insoluble content (%) | 19.9 | 70.6 | 8.9 |
| Trona Grade (%) | 80.1 | 29.4 | 91.1 |
| Trona Recovery (%) | 100 | 6.5 | 93.5 |

Operating parameters: Feed rate = 27-37 kg/hr, Splitter angle = 90-92° (coarsest size-fraction) and 95-98° (intermediate and fine size-fraction), and Roll speed = 30-40% of maximum voltage setting

TABLE 5
Overall results of magnetic separation of the fine trona sample
(0.30 × 0.15 mm)

| 0.30 × 0.15 mm | | |
|---|---|---|
| Feed | Magnetic | Non-Magnetic |

Stage I

| | | | |
|---|---|---|---|
| Weight (%) | 100 | 15.8 | 84.2 |
| Insoluble content (%) | 15.9 | 55.6 | 8.6 |
| Trona Grade (%) | 84 | 44.4 | 91.4 |
| Trona Recovery (%) | 100 | 8.4 | 91.6 |

Stage II

| | | | |
|---|---|---|---|
| Weight (%) | 100 | 5.5 | 94.5 |
| Insoluble content (%) | 8.6 | 29.4 | 7.4 |
| Trona Grade (%) | 91.4 | 70.6 | 92.7 |
| Trona Recovery (%) | 100 | 4.2 | 95.8 |

Overall

| | | | |
|---|---|---|---|
| Weight (%) | 100 | 20.5 | 79.6 |
| Insoluble content (%) | 15.9 | 49.6 | 7.4 |
| Trona Grade (%) | 84 | 50.4 | 92.7 |
| Trona Recovery (%) | 100 | 12.3 | 87.7 |

Operating parameters: Feed rate = 27-37 kg/hr, Splitter angle = 90-92° (coarsest size-fraction) and 95-98° (intermediate and fine size-fraction), and Roll speed = 30-40% of maximum voltage setting

The single separation improved the trona grade from 80.4% in the feed to 92.1% with a recovery of 95.9% for the 1.0×0.6 mm size fraction. The second stage magnetic separation of the non-magnetic concentrate obtained from the first stage of separation further improved the trona recovery in the second stage to 98.8% with a marginal increase in grade from 92.1% to 92.8%. The combined results of two stage separation indicate that a trona concentrate of 82.1% by weight could be obtained with 94.8% recovery and a purity of 92.8%.

The trona grade improved from 80.1% in the feed to 90.1% in the concentrate with a recovery of 95.0% during the first stage of separation for the 0.6×0.3 mm size fraction. The second stage separation further improved the trona recovery in the second stage to 98.2% with a marginal increase in grade from 90.1% to 91.1%. The overall results indicate that a trona concentrate of 82.2% by weight could be obtained with recovery and grade of 93.4% and 91.1%, respectively.

For the 0.30×0.15 mm size fraction, the single stage separation increased the trona grade from 84.0% to 91.4% with a recovery of 91.6%. The second stage separation further improved the recovery to 95.8% with a marginal increased in grade to 92.7%. The combined results of two stage magnetic separation indicated that trona concentrate of 79.6% by weight could be obtained with recovery of 87.8% and grade of 92.7%. Trona recovery decreased from 94.8% for the coarse size fraction to 87.8% for the fine size fraction with substantially similar grade due to a decrease in magnetic separation efficiency for the fine size feed material.

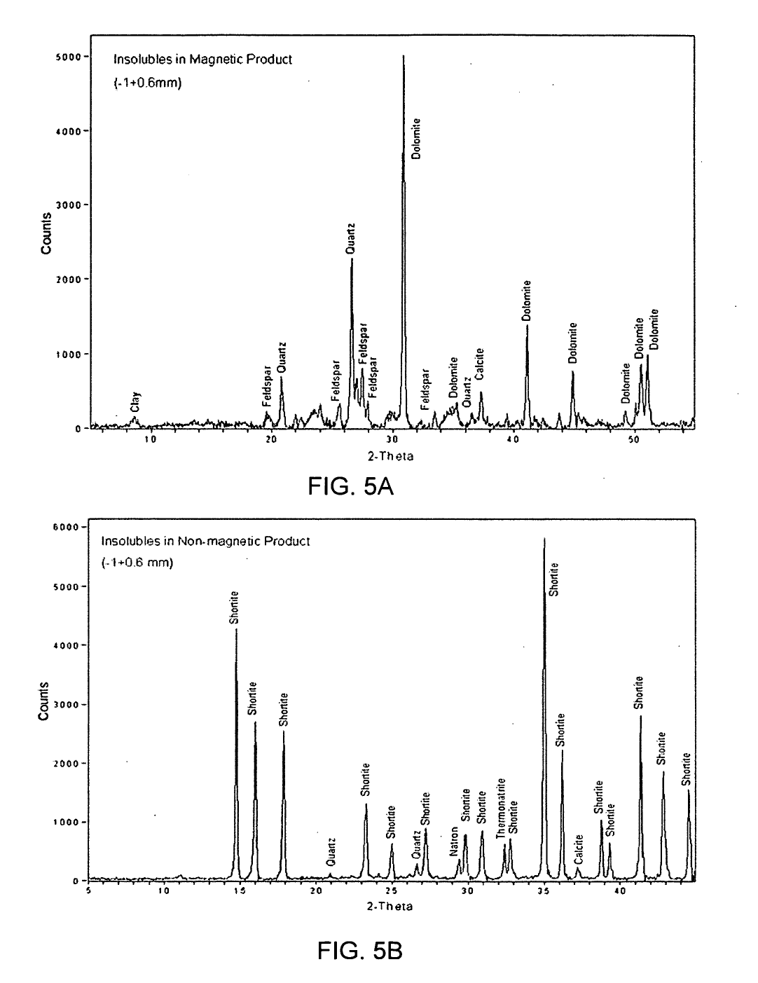

The products from magnetic separation of trona ore were analyzed by X-ray diffraction (XRD) in order to determine the different minerals reporting to the magnetic and non-magnetic streams. XRD analyses indicated that most of the colored impurities such as dolomitic shale, feldspars and clay minerals were removed in the magnetic product. The insoluble impurities remaining in the non-magnetic trona concentrate were mostly shortite. The results of the XRD analysis of the coarse trona sample (1.0×0.6 mm) from the magnetic separation are presented in FIG. 5. The results of the XRD of the intermediate-size and fine-size trona samples (not shown here) were found to have similar mineral compositions to the coarse trona sample.

Quartz and feldspar, which are understood to be diamagnetic minerals, were reported in the magnetic product. These minerals are likely locked in dolomitic shale particles and thus have sufficient magnetic character to separate into the magnetic products. The dolomitic shale and illite, which are paramagnetic minerals of higher susceptibility, could be relatively easily separated by high intensity magnetic separation. On the other hand, shortite, a diamagnetic mineral, may not typically be separated from trona ore using magnetic separation. Accordingly, separation by flotation was used as a second process to produce high purity trona concentrate from the non-magnetic product obtained from magnetic separation.

Flotation was conducted on each size-fraction of the non-magnetic concentrates from magnetic separation in a bench-scale Denver Flotation machine. A collector emulsion (mixture of amine solution (3%) and kerosene in ratio of 1:12) was used to float the insoluble impurities from trona. Conditioning was done with the collector emulsion and brine solution for about two minutes followed by flotation in the brine solution. The reagent dosage, conditioning time, and flotation time were kept constant for all experiments. The flotation results for each size fraction are presented in Table 6. The operating parameters for flotation are also listed in the table.

TABLE 6
Results of flotation of non-magnetic product

| | 1 × 0.6 mm | | | 0.6 × 0.3 mm | | | 0.30 × 0.15 mm | | |
|---|---|---|---|---|---|---|---|---|---|
| % | Feed | Float | Sink | Feed | Float | Sink | Feed | Float | Sink |
| Weight | 100 | 9.6 | 90.4 | 100 | 22.1 | 77.9 | 100 | 20.9 | 79.1 |
| Insoluble content | 7.0 | 19.6 | 5.6 | 8.2 | 30.5 | 1.9 | 7.0 | 26.1 | 2.0 |
| Trona Grade | 93.0 | 80.4 | 94.4 | 91.8 | 69.5 | 98.1 | 93.0 | 73.9 | 98.0 |
| Trona Recovery | 100 | 8.3 | 91.7 | 100 | 16.7 | 83.3 | 100 | 16.6 | 83.4 |

Operating parameters: Amine Dosage = 4 kg/t, kerosene:Amine ratio = 1:12; Conditioning Time = 2.0 min

There was only a slight increase in trona grade from 93% in the feed to 94% in the concentrate of 1.0×0.6 mm size-fraction, which may be due to increased detachment of particles from the air bubbles with increase in particle size because of the particle weight and turbulence during flotation. The flotation for the coarser size-fraction may be possible by special flotation units such as hydrofloat.

In contrast, greater flotation separation efficiency for intermediate and fine size-fractions was achieved and trona grade was improved from 92% in the feed to 98% in the concentrate. These results indicate that the trona particles of size less than 0.6 mm could be recovered by flotation effectively. The combined results of flotation of 0.6×0.3 mm and 0.30×0.15 mm size-fractions are presented in Table 7.

TABLE 7
Combine results of flotation of intermediate (0.6 × 0.3 mm) and
fine size (0.3 × 0.15 mm) trona ore

| | Weight | Trona Content | Trona Recovery |
|---|---|---|---|
| Products | (%) | (%) | (%) |
| Float | 21.5 | 71.7 | 16.7 |
| Sink | 78.5 | 98.1 | 83.3 |
| Feed | 100.0 | 92.4 | 100.0 |

The results show that insoluble particle in the fine size trona ore (less than 0.6 mm) were successfully recovered and trona concentrates containing 98.1% trona with 83.3% recovery was obtained by flotation. It was indicated from flotation that it is difficult to float trona ore coarser than 0.6 mm. The above results verify that by using magnetic separation followed by flotation of the non-magnetic concentrate that it is possible to produce a high-grade trona concentrate. The non-magnetic concentrate from 1.0×0.6 mm could be utilized directly by industries or could be utilized by further treatment from a special flotation unit such as a hydrofloat. The non-magnetic concentrate from 0.6×0.15 mm size fraction could optionally be further treated by flotation to again increase the trona grade. Overall results are presented in Tables 8 and 9.

TABLE 8
Magnetic separation and flotation of 0.6 × 0.3 and
0.3 × 0.15 mm size trona ore
Results of two stage magnetic separation

| | Feed | | Nonmagnetic Product | | |
|---|---|---|---|---|---|
| | Weight | Trona | Weight | Trona | Recovery |
| Size Fraction | (%) | (%) | (%) | (%) | (%) |
| 0.6 × 0.3 mm | 59.3 | 80.1 | 48.7 | 91.1 | 93.5 |
| 0.3 × 0.15 mm | 40.7 | 84.0 | 32.4 | 92.7 | 87.7 |
| Total | 100.0 | 81.7 | 81.1 | 91.7 | 91.1 |

TABLE 9
Magnetic separation and flotation of 0.6 × 0.3 and
0.3 × 0.15 mm size trona ore
Results of flotation

| | Feed | | Flotation Concentrate | | |
|---|---|---|---|---|---|
| | Weight | Trona | Weight | Trona | Recovery |
| Size Fraction | (%) | (%) | (%) | (%) | (%) |
| 0.6 × 0.3 mm | 48.7 | 91.1 | 38.0 | 98.1 | 83.9 |
| 0.3 × 0.15 mm | 32.4 | 92.7 | 25.6 | 98.0 | 83.6 |
| Total | 81.1 | 91.7 | 63.6 | 98.1 | 83.8 |

### Example 2

Generally, in the case of flotation, a saturated solution of trona ore, e.g. supersaturated, can be used so that the trona will not dissolve in the brine. Three compositions of particular interest: the saturated solution which can be used for flotation tests, trona product coming from magnetic separation as a nonmagnetic product, and forming the emulsion (oil+amine). First, the trona product can be put into a small cell. Then saturated solution is added to the trona product, and mixed for about 30 seconds to clear trona surfaces. The emulsion is added into the trona product (conditioned with the brine) and mixed for about 2 min at 75% solid weight. For example, if 150 gm of trona product is used, in order to reach the 75% solid weight, addition of 50 gm of trona+emulsion would be performed. After the conditioning process, the conditioned sample is transferred to the flotation cell. Extra brine can be added in the flotation cell to reach 15% solid weight and flotation is performed immediately.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

1. A process of producing high purity trona concentrate comprising:
(a) crushing a mined raw trona to form a crushed raw trona;
(b) separating the crushed raw trona into at least two size fractions, a first size fraction being larger than a second size fraction;
(c) selectively independently adjusting at least two magnetic separators to optimize magnetic separation of magnetic impurities from respective size fractions of the at least two size fractions, wherein each of the at least two magnetic separators corresponds to one of the at least two size fractions; and
(d) separately introducing each of the at least two size fractions into corresponding magnetic separators of the at least two magnetic separators to undergo at least a single stage of magnetic separation to remove magnetic impurities from each of the at least two size fractions of the crushed raw trona, leaving at least two high purity dry tronas including at least a first high purity dry trona and a second high purity dry trona recovered from the first and second size fractions, respectively.

2. The process of claim 1, further comprising combining the each of the at least two high purity dry tronas to form a magnetically purified dry trona.

3. The process of claim 1, wherein the step of separating the crushed raw trona into at least two size fractions includes separating the crushed raw trona into at least three size fractions, a third size fraction being smaller than each of the first and second size fractions.

4. The process of claim 1, wherein the single stage of magnetic separation comprises:
(a) feeding a stream of trona particles into a hopper;
(b) unloading one of the at least two size fractions onto a vibratory feeder;
(c) passing the one of the at least two size fractions over a magnetic roller sufficient to magnetically retain at least a portion of the magnetic impurities on the magnetic roller;
(d) collecting substantially non-magnetic, high purity trona particles from the magnetic roller; and
(e) removing the portion of the magnetic impurities from the magnetic roller.

5. The process of claim 1 wherein each of the at least two size fractions undergo at least two stages of magnetic separation to remove magnetic impurities.

6. The process of claim 1, wherein the step of selectively independently adjusting at least two magnetic separators to optimize magnetic separation includes adjustment of at least one of magnetic roller speed, size fraction feed rate, separation baffle angle, and magnetic roller type.

7. The process of claim 6, wherein the step of selectively independently adjusting at least two magnetic separators to optimize magnetic separation includes adjustment of size fraction feed rate.

8. The process of claim 7, wherein the size fraction feed rate is from about 3.3 tph/m to about 33.3 tph/m.

9. The process of claim 1, further comprising separating gangue materials from the magnetically purified dry trona by flotation to produce an ultra high purity trona concentrate, said flotation comprising:
a) emulsifying an oil in an aqueous solution to form an oil-in-water emulsion;
b) forming a saturated trona brine;
c) adding the magnetically purified dry trona to the saturated brine to form a saturated trona suspension, said magnetically purified dry trona including trona and gangue material;
d) conditioning the trona by mixing the saturated trona suspension and the oil-in-water emulsion to form a conditioning solid suspension of the trona and the gangue material; and
e) separating the gangue material from the trona to form the ultra high purity trona concentrate.

10. The process of claim 9, further comprising a step of diluting the conditioning solid suspension by adding supplemental saturated brine.

11. The process of claim 9, wherein the conditioning solid suspension has a solids content from about 60% to about 75%.

12. The process of claim 9, wherein an emulsifier is used in the emulsifying step.

13. The process of claim 12, wherein the emulsifier comprises a compound with an amine functionality.

14. The process of claim 12, wherein the emulsifier is an amine-containing surfactant.

15. The process of claim 1, wherein the process is substantially free of calcination.

16. The process of claim 1, wherein at least one of the magnetic separators produces a magnetic field that is less than about 20,000 Gauss on the surface of a roll.

17. The process of claim 16, wherein the at least two magnetic separators produce a magnetic field that is less than about 20,000 Gauss on the surface of a roll.

18. A system to produce high purity trona concentrate comprising:
(a) a crusher having a raw trona ore therein and configured to form a crushed raw trona from the raw trona ore, said crushed raw trona having non-uniform sized particles;
(b) a mechanical sizer oriented downstream of the crusher to divide the non-uniform sized particles into at least two size fractions, a first size fraction being larger than a second size fraction;
(c) a plurality of magnetic separators each having at least a single stage and oriented to independently receive one of the at least two size fractions; and
(d) a vessel operatively associated with each of the plurality of magnetic separators and being configured to hold a magnetically purified dry trona.

19. The system of claim 18, wherein the magnetically purified dry trona comprises a mixture of the at least two size fractions after each has passed through a corresponding magnetic separator.

20. The system of claim 18 wherein each of the plurality of magnetic separators can be selectively adjusted to optimize magnetic separation of each size fraction.

21. The system of claim 18, wherein the mechanical sizer divides the particles into at least three size fractions, the first size fraction being larger than the second size fraction, and the second size fraction being larger than a third size fraction.

22. The system of claim 21, wherein the first size fraction comprises particles having a size ranging from about 1.0 mm to about 0.6 mm, the second size fraction comprises particles having a size ranging from about 0.6 mm to about 0.3 mm, and the third size fraction comprises particles having a size ranging from about 0.3 mm to about 0.15 mm.

23. The system of claim 18, wherein each of the plurality of magnetic separators comprises:
(a) a conveyor belt;
(b) a hopper to temporarily hold and discharge one of the at least two size fractions of the crushed trona ore onto the conveyor belt;
(c) a magnetic roller associated with the conveyor belt and being configured to release substantially non-magnetic particles and to retain substantially magnetic particles;
(d) a splitter oriented spaced from and near the magnetic roller sufficient to segregate the non-magnetic particles from the magnetic particles;
(e) a first receiving member oriented to collect the substantially non-magnetic particles; and
(f) a second receiving member oriented to collect the substantially magnetic particles.

24. The system of claim 23, wherein the magnetic roller is configured to apply magnetic force, centrifugal force, and gravitational force to the trona particles to facilitate separation of the substantially magnetic particles and substantially non-magnetic particles.

25. The system of claim 23, further comprising a vibratory feeder oriented above the conveyor belt and configured to distribute trona particles over the conveyor belt.

26. The system of claim 23, wherein the splitter is a moveable separation baffle oriented to direct non-magnetic materials separately away from magnetic impurities.
